(19) United States
(12) Patent Application Publication
(10) Pub. No.: US 2009/0317099 A1
(43) Pub. Date: Dec. 24, 2009

(54) IMAGE FORMING APPARATUS

(75) Inventors: Kosuke MASUMOTO, Sagamihara-shi (JP); Hiroyuki MARUYAMA, Toshima-ku (JP); Toshihiro MOTOI, Kunitachi-shi (JP); Satoshi OGATA, Hachioji-shi (JP); Katsunori TAKAHASHI, Hino-shi (JP); Eiji NISHIKAWA, Hino-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/480,852

(22) Filed: Jun. 9, 2009

(30) Foreign Application Priority Data
Jun. 19, 2008 (JP) 2008-160115

(51) Int. Cl. G03G 15/02

(52) U.S. Cl. 399/31

(57) ABSTRACT

An image forming apparatus according to the present invention includes a replaceable unit in which a plurality of replaceable parts are installed, a storage section to store a replacement time count value, a life duration time count value and a use count value, a display section and a control section to update the use count value in the storage section by counting the number of times of use of each of the parts installed in the unit, to determine whether a part which reached the life duration time exists or not based on the use count value of each of the parts which are update and the life duration time count value, and to display information for urging a replacement of the part which reached the life duration time and a part in which the use count value reached between the replacement time count value and the life duration time count value in the display section when the control section determines that the part which reached the life duration time exists.

### BACKGROUND OF THE INVENTION

1. Field of the Invention

The present invention relates to an image forming apparatus.

2. Description of Related Art

Conventionally, there is known an image forming apparatus comprising a detachable unit in which a plurality of replaceable parts are grouped in one. In such image forming apparatus, when a part reached its life duration or when the part breaks down, an unit in which the part is installed is pulled out from the image forming apparatus and is replaced. The unit after the replacement is collected, and is reused by the part which reached its life duration or which broke down being replaced with a new part (for example, see JP 2005-107440 (hereinafter, called patent document 1)).

Conventionally, replacement of a unit in an image forming apparatus has been carried out at the time of routine maintenance by a service man which is carried out in a predetermined time cycle. In the commercial printing market, many of the vendors accept orders of a mass printing amount in quick delivery. Such vendors do not prefer reduction in productivity due to the long term termination (down time) of the image forming apparatus caused by bad unit or routine maintenance of the image forming apparatus. Therefore, it is desired to reduce the down time by a user replacing the unit without waiting for a service man when a part approaches its life duration or when a part beaks down.

In response to such desire, there is suggested an image forming apparatus with a design of improved replaceability of units. For example, there is known an image forming apparatus which measures life durations of parts of each unit and which urges a user to replace the unit by warning a user that it is a replacement time when the life duration approaches. In such apparatus, a user pulls out the unit which has been warned from the image forming apparatus and replaces with a backup unit.

Here, by referring to FIGS. 11A and 11B, a unit replacement time in a case where the conventional unit replacement which has been carried out by a service man at the time of routine maintenance is carried out by a user. In FIGS. 11A and 11B, the routine maintenance is carried out in a cycle of 2 million print cycle, and the replacement time (shown as MC in FIGS. 11A and 11B) of the roller 1, the roller 2, the belt and the sleeve which are installed in the fixing unit are set to every 200,000 prints, every 200,000 prints, every 400,000 prints and every 600,000 prints, respectively, according to the cycle of the routine maintenance in advance. FIG. 11A shows a case where break down of a part which is installed in the fixing unit has not occurred and where the unit replacement was carried out only at the time of routine maintenance, and the unit replacement is carried out at the time shown in dashed line. The number of times of the unit replacement up to 2 million prints is 10 times. At the time of unit replacement, a user replaces the whole unit and a service man collects the unit and carries out the part replacement of the replaced unit at a base.

When a user carries out the unit replacement, the apparatus itself manages the number of times each part is used (count value of number of sheets printed), determines whether each part reached the time where the part needs to be replaced or not based on the number of times each part is used. When the part reached the replacement time, the apparatus urges a user to replace the unit including the part and there is no room for a service's determination to intervene as in the conventional case. Therefore, for example, when the roller 1 breaks down and is replaced before reaching the 400,000 prints (for example, at the time of 370,000 prints) which is the next replacement time after the roller 1 is replaced once after reaching 200,000 prints as shown in FIG. 11B, counting of the number of sheets printed for measuring a new replacement time from the time of replacement is started and the next replacement time of the roller 1 is set to 570,000 sheets. As a result, a unit replacement occurs in a cycle different from the unit replacement of routine maintenance. The same applies to other parts, and when break down occurs irregularly, a replacement cycle specific for the part which is different from the cycle of routine maintenance is added causing a problem that the frequency for a user to carry out unit replacement increases. For example, when the routine maintenance cycle and the replacement time of each part is set as shown in FIG. 11A, unit replacement needs to be carried out 25 time until 2 million sheets are printed when irregular break downs respectively occur in the roller 1, the belt and the sleeve at a timing shown in FIG. 11B.

### SUMMARY OF THE INVENTION

An object of the present invention is to attempt to reduce the down time in the image forming apparatus by reducing the unit replacement frequency where a user carries out the unit replacement.

In order to solve the above problem, according to a first aspect of the present invention, an image forming apparatus comprises a replaceable unit in which a plurality of replaceable parts are installed, a storage section to store a replacement time count value showing a replacement time of each or the parts installed in the unit, a life duration time count value showing a life duration time of each of the parts and a use count value showing a number of times of use of each of the parts, a display section and a control section to update the use count value in the storage section by counting the number of times of use of each of the parts installed in the unit, to determine whether a part which reached the life duration time exists or not based on the use count value of each of the parts which are update and the life duration time count value, and to display information for urging a replacement of the part which reached the life duration time and a part in which the use count value reached between the replacement time count value and the life duration time count value in the display section when the control section determines that the part which reached the life duration time exists.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a block diagram showing a functional structure of an image forming apparatus in the embodiment of the present invention;

FIG. 2 is a diagram showing an example of data storage in a storage section of FIG. 1;

FIG. 3 is a diagram showing a main structure of a printer section of FIG. 1;

FIG. 4 is a diagram showing an example of data storage in IC tag of FIG. 1;

FIG. 5 is a flowchart showing a unit replacement check process to be executed by a control section or FIG. 1;

FIG. 6 is a flowchart showing a print process to be executed by the control section of FIG. 1;

FIG. 7 is a diagram showing an example of a notification screen to be displayed in an operation section and in a display section of FIG. 1;

FIG. 8 is a flowchart showing a maintenance mode process to be executed by the control section of FIG. 1;

FIG. 9 is a flowchart showing a part replacement procedure carried out by a service man;

FIG. 10A is a diagram showing a replacement time count value, a life duration time count value and a period from the replacement time count value to the life duration time count value of each part in a fixing unit;

FIG. 10B is a diagram showing a unit replacement time when 2 million prints is reached without any breakdown of a part occurring in the embodiment;

FIG. 10C is a diagram showing a unit replacement time when breakdown of parts occurred three time until reaching 2 million prints in the embodiment;

FIG. 11A is a diagram showing a unit replacement time in a convention unit replacement in a routine maintenance when 2 million prints is reached without any breakdown of parts occurring; and

FIG. 11B is a diagram showing a unit replacement time in a convention unit replacement in a routine maintenance when breakdown of parts occurred three time until reaching 2 million prints.

### DESCRIPTION OF THE PREFERRED EMBODIMENTS

Hereinafter, an embodiment of the present invention will be described in detail with reference to the drawings.

First, a structure will be described.

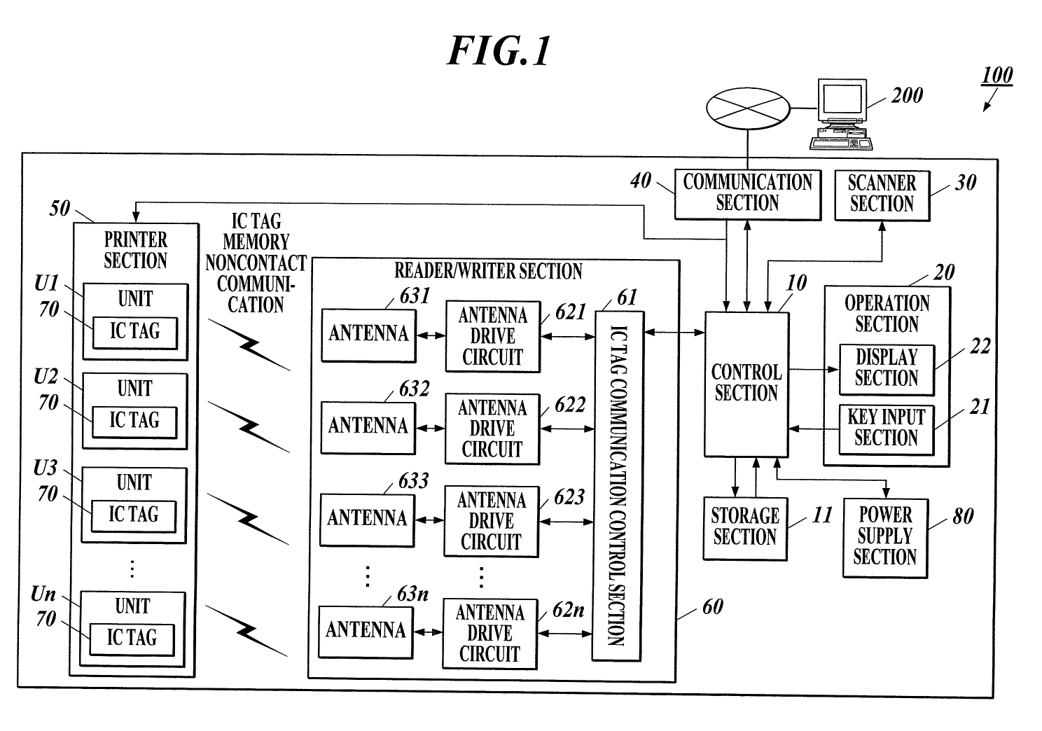

In FIG. 1, an example of a functional structure of the image forming apparatus 100 of the embodiment is shown. As shown in FIG. 1, the image forming apparatus 100 comprises a control section 10, an operation section 20, a scanner section 30, a communication section 40, a printer section 50, a reader/writer section 60 a power supply section 80 and the like.

The control section 10 is constituted with a CPU (Central Processing Unit), a ROM (Read Only Memory), a RAM (Random Access Memory) and the like. Various types of process programs are stored in the ROM of the control section 10, and the CPU of the control section 10 reads the various types of programs stored in the ROM and expands the programs in the RAM and controls the operation of each part of the image forming apparatus 100 according to the expanded programs.

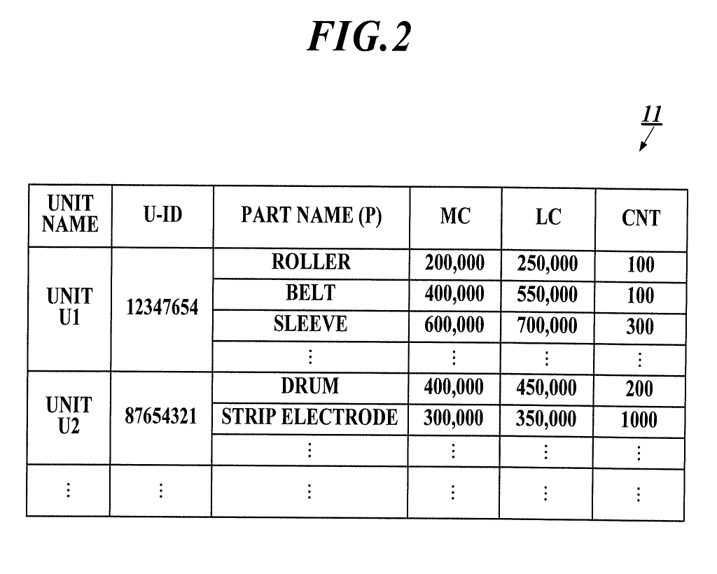

The storage section 11 which is constituted with a non-volatile memory is connected to the control section 10. The storage section 11 stores a replacement time count value MC, a life duration time count value LC and a use count value CNT. Here, as shown in FIG. 1, replaceable units U1 to Un in which a plurality of parts P which are replaceable are installed are provided at the printer section 50 of the image forming apparatus 100. As an example is shown in FIG. 2, identification information (called, U-ID) of a unit and the replacement time count value MC, the life duration time count value LC and the use count value CNT of each part P which is installed in the unit are stored in the storage section 11 for each of the units U1 to Un which are installed in the printer section 50.

The replacement time count value MC is a print count value showing a replacement time of a part P, and is set by a maker for each part P so as to have a certain time of grace period till the life duration count value. The life duration count value LC is a print count value showing a life duration time of a part P, and is a value set by a maker based on a number of sheets printed which is a limit where the maker cannot assure the quality of the printed matter when the part is used thereafter, for example.

Here, as for the replacement time count value MC, a conventional maintenance count which is set as the part replacement time at the time of routine maintenance by a service man can be used. In order to reduce the number of routine maintenance for the part replacement, the maintenance count is set by a maker so that the parts P in which the difference between the life duration count value LC is within a certain range can be replaced at once at the time of routine maintenance.

The use count value CNT is a print count value in which the part P has been used.

The operation section 20 comprises the key input section 21, the display section 22 and the like.

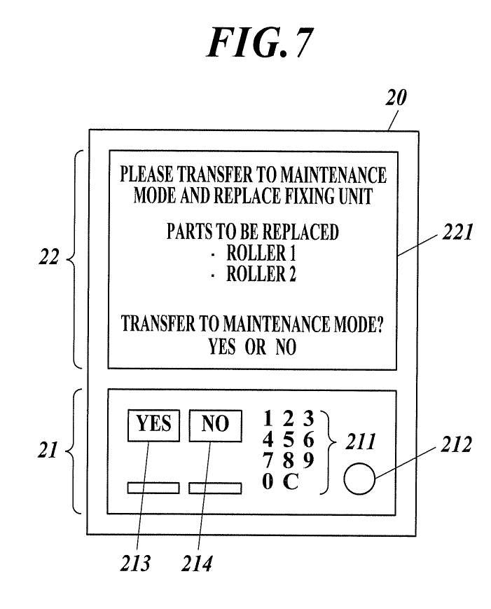

The key input section 21 comprises various types of operation keys (see FIG. 7) such as ten keys 211, a start key 212, a YES key 213, a NO key 214, a power supply key for switching ON/OFF of the power supply and the like, and the operation signal by the key operation is outputted to the control section 10.

The display section 22 is constituted with a LCD (Liquid Crystal Display) and the like, and displays various types of operation screens, a condition display of an image, an operation condition of each function and the like according to an instruction of a display signal inputted from the control section 10.

The scanner section 30 comprises a platen glass, a CCD (Charge Coupled Device) and a light source. The scanner section 30 reads an image of a document which is set at a predetermined position as signals of R, G and B by imaging the reflection light of a light which is illumination scanned to the document from the light source by the CCD to carry out the photoelectric conversion, and converts the read analog image signal to image data of R, G and B to output to the control section 10.

The communication section 40 is an interface which can be connected to a transmission medium connected to the communication network such as the LAN (Local Area Network), the WAN (Wide Area Network) and the like. The communication section 40 is constituted with a communication control card such as a LAN card or the like, for example, and carries out sending and receiving of various types of data between an external device of the host device 200 or the like which is connected to the communication network via the communication circuit such as the LAN cable or the like.

The printer section 50 forms an toner image on a paper by the electrophotographic process based on the image data inputted from the control section 10.

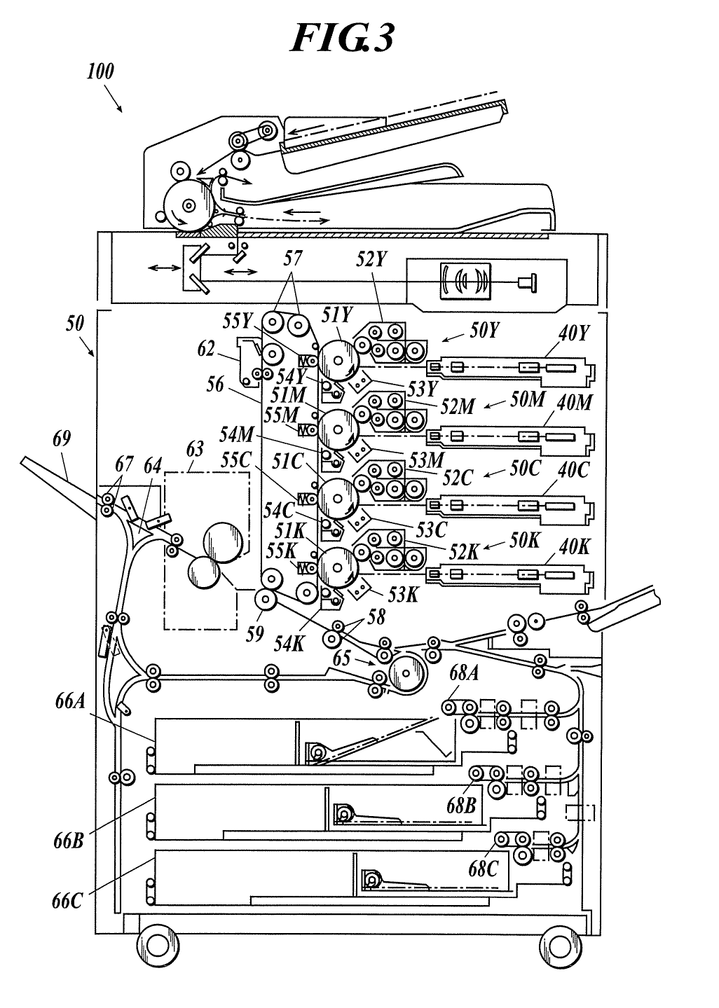

In FIG. 3, a main structure of the printer section 50 is shown. As shown in FIG. 3, the printer section 50 comprises laser sections 40Y, 40M, 40C and 40K which write the latent image on the photoconductor drums by exposing laser to the photoconductor drums 51Y, 51M, 51C and 51K based on the image data inputted by the control section 10, image forming sections 50Y, 50M, 50C and 50K which form toner images of each color of Y, M, C and K, an intermediate transfer belt 56 as an intermediate transferring body to which the toner images formed at the image forming sections 50Y, 50M, 50C and 50K are temporarily transferred, a resist roller 58 which conveys a paper to the secondary transfer roller 59 by synchronizing with the toner image formed on the intermediate transfer belt 56, a secondary transfer roller 59 which carries out the secondary transfer of the toner images which are formed on the intermediate transfer belt 56 to the paper, a fixing unit 63 to fix the toner images on the paper and a paper ejection roller 67 which ejects the paper.

The image forming section 50Y comprises the photoconductor drum 51Y, the developer 52Y, the charger 53Y, the cleaner 54Y and the primary transfer roller 55Y. The image forming sections 50M, 50C and 50K are also structured in a similar manner.

Here, the print operation in the printer section 50 will be described. First, in the image forming section 50Y, the photoconductor drum 51Y is rotated and the surface of the photoconductor drum is charged by the charger 53Y, and a latent image of the Y data is formed at the charged portion by the exposure of the laser light source of the laser section 40Y. Then, the latent portion is developed by the developer 52Y to form the toner image of yellow. The toner image is primary transferred to the intermediate transfer belt 56 by the pressing of the primary transfer roller 55Y. The toner image becomes the image of yellow corresponding to the image data of the output subject. Toner which was not primary transferred is removed by the cleaner 54Y.

In the image forming section 50M, 50C and 50K, a toner image of magenta, the toner image of cyan and a toner image of black are respectively formed and transferred in a similar manner. The intermediate transfer belt 56 is rotated by the rotation of the roller 57, the primary transfer rollers 55Y, 55M, 55C and 55K, the secondary transfer roller 59, and the toner image of YMCK are orderly layered on the intermediate transfer belt 56 to be transferred. Further, paper is conveyed one by one from any of the paper feeding trays 66A to 66C by any of the paper feeding rollers 68A to 68C rotating, and the paper is conveyed to the secondary transfer roller 59 by the rotation of the resist roller 58.

When the paper passes through the pressing section of the secondary transfer roller 59, the toner image of YMCK on the intermediate transfer belt 56 is secondary transferred to the paper. The paper on which the toner image of YMCK is transferred passes through the fixing unit 63. By the pressuring and heating by the fixing unit 63, the toner image of YMCK is fixed on the paper and the colored toner image is formed. The paper on which the image is formed is ejected by the paper ejection roller 67.

When images are to be formed on both sides, the paper in which an image is formed on one side (front side) is sent to the both-side conveyance unit 65 by the conveyance switching board 64 and the surface of the paper is reversed by the both-side conveyance unit 65. Then, the paper is conveyed to the secondary transfer roller 59 by the resist roller 58 so that the image forming is to be carried out again to the surface (back side) on which an image is not formed to carry out the image forming. The paper on which images are formed on both sides and in which the toner is fixed is conveyed to the paper ejection tray 69 and the like by the paper ejection roller 67.

After forming images on the paper, residual toner on the intermediate transfer belt 56 is removed by the belt cleaning 62. Further, by applying a current of plus polarity and a current of minus polarity from the power supply 67 to the secondary transfer roller 59 by switching between the currents for a predetermined period of time, the residual toner at the secondary transfer roller 59 is retransferred to the intermediate transfer belt 56 to carry out the cleaning of the secondary transfer roller 59.

Each part of the printer section 50 described above is driven via various types of motors (omitted from the drawing) by a command of the control section 10.

Here, the printer section 50 is constituted by using a plurality of replaceable units U1 to Un as described above. In each of the units U1 to Un, one or a plurality of parts P (including replaceable parts P) are collected and grouped as individual assemblies. For example, such as optical units of each color of Y, M, C and K in which parts P which constitute each of the laser sections 40Y, 40M, 40C and 40K are grouped together, image forming units of each color of Y, M, C and K in which parts P which constitute each of the image forming sections 50Y, 50M, 50C and 50K are grouped together, the fixing unit 63 and the like. When a part P of the printer section 50 reached the part replacement time, the unit in which the part P which is the replacement target is installed is pulled out by a user and the unit is replaced with a unit in which a new part P is installed.

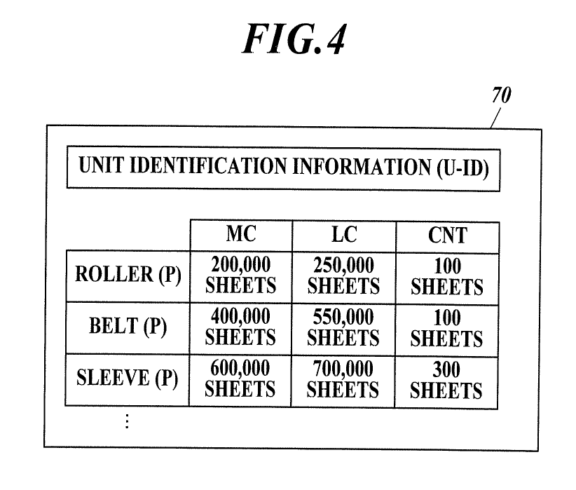

In the embodiment, the IC tag 70 as a recording medium is attached to each of the units U1 to Un which are installed in the printer section 50. In FIG. 4, an example of data storage in the IC tag 70 is shown. As shown in FIG. 4, the U-ID for identifying the unit to which the IC tag 70 is attached and the replacement time count value MC, the life duration time count value LC and the use count value CNT for each of the parts P (for example, a roller, a belt, a sleeve . . . ) which are installed in the unit are stored in the IC tag 70.

Here, in the embodiment, the replacement time count value MC, the life duration time count value LC and the use count value CNT of each of the parts P are stored in the IC tag 70 to manage the information. However, only the U-ID may be stored in the IC tag 70 and the replacement time count value MC, the life duration time count value LC and the use count value CNT of each of the parts P may be stored in the external device such as a server by being corresponded with the U-ID.

The reader/writer section 60 comprises an IC tag communication control section 61, an antenna drive circuits 621 to 62n and the antennas 631 to 63n. The antenna, drive circuits 621 to 62n and the antennas 631 to 63n are respectively corresponded to the units U1 to Un, and the antenna 631 to 63n are respectively provided at positions opposite to the units U1 to Un. The IC tag communication control section 61 controls the antenna drive circuits 621 to 62n based on the instruction from the control section 10 and electromagnetically induces the IC tag 70 of the units U1 to Un via the antennas 631 to 63n to carryout sending and receiving of data by noncontact communication. Then, reading and writing of the data to the IC tag 70 of the units U1 to Un are carried out.

The power supply section 80 is connected to the commercial AC power supply (omitted from the drawing), and converts the AC source power inputted from the commercial AC power supply to the DC source power to supply to each of the parts which needs electric voltage. The power supply section 80 supplies power according to the control command from the control section 10.

Next, the operation in the embodiment will be described.

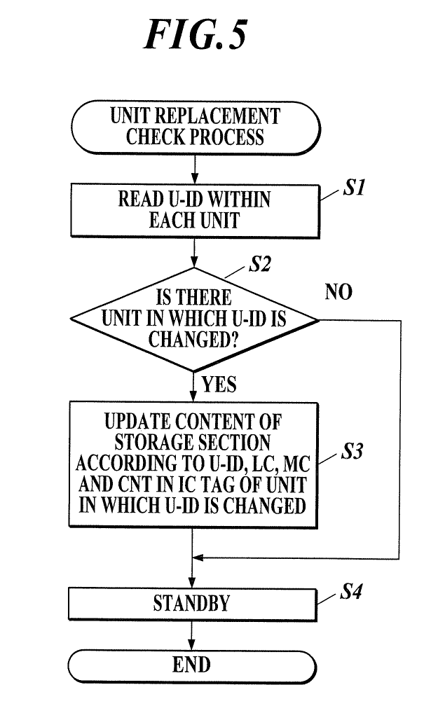

In the image forming apparatus 100, first, the unit replacement check process (see FIG. 5) is executed at the time when the power supply is turned ON to check whether unit replacement was carried out while the power supply of the main body is OFF.

In FIG. 5, a flow of the unit replacement check process to be executed by the control section 10 at the time when the power supply is turned ON is shown.

First, the U-ID is read from each of the IC tags 70 attached to the units U1 to Un installed in the printer section 50 via the reader/writer section 60 (step S1).

Next, whether a unit in which the U-ID is changed exists or not is determined by comparing the U-ID read from the IC tags 70 of the Units U1 to Un to the U-ID of the units U1 to Un stored in the storage section 11 (step S2).

When it is determined that a unit in which the U-ID is changed does not exist (step S2; NO), the image forming apparatus is switched to a standby state (step S4) and the process is finished.

On the other hand, when it is determined that there is a unit in which the U-ID is changed (step S2; YES), the U-ID in the IC tag 70 of the unit in which the U-ID is changed and the replacement time count value MC, the life duration time count value LC and the use count value CNT of each of the parts P are read via the reader/writer section 60 to update the storage section 11 (step S3). Then, the image forming apparatus is switched to a standby state (step S4) and the process is finished.

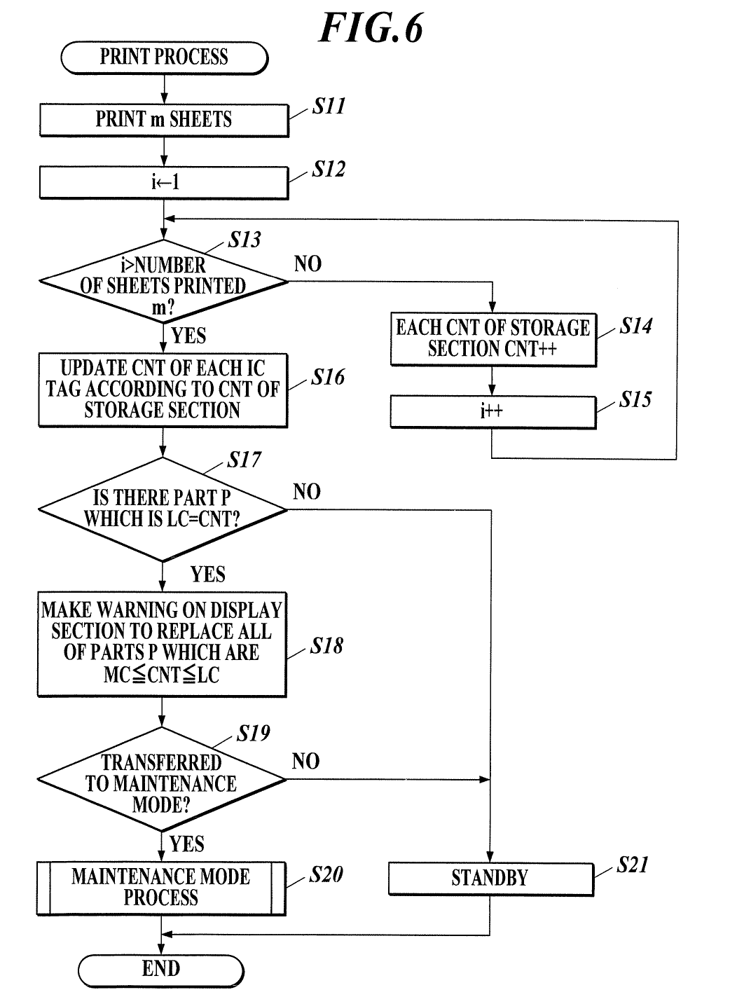

After the above described unit replacement check process, the image forming apparatus 100 will be in a standby state. However, when a job execution is instructed via the operation section 20 or the communication section 40, the print process (see FIG. 6) is executed.

In FIG. 6, a flow of the print process to be executed by the control section 10 is shown.

In the print process, first, printing of the number of sheets to be printed (set to number of sheets printed m) which is instructed via the operation section 20 or the communication section 40 is executed (step S11). Next, the counter i is set to 1 (step S12), and 1-count up (step S14) and the 1-incliment (step S15) of the use count value CNT of each of the parts P in the storage section 11 are repeated until i>number of sheets printed m is achieved.

When it is determined that i>number of print sheets m (step S13; YES), the use count value CNT of each part P in the IC tag 70 of the units Un to Un is updated according to the use count value CNT of each part P in the storage section 11 via, the reader/writer section 60 (step S16).

Next, the storage section 11 is referred to determine whether a part P in which the life duration time count value LC=the use count value CNT exists or not (step S17). When it is determined that a part P in which the life duration time count value LC=the use count value CNT does not exist (step S17; NO), the image forming process is switched to a standby state (step S21) and the process is finished.

On the other hand, when it is determined that a part P in which the life duration time count value LC=the use count value CNT exists (step S17; YES), a part P in which the replacement time count value MC≦the use count value CNT≦the life duration time count value LC is detected in the storage section 11 and an notification screen 221 which urges to replace all of the parts P in which the replacement time count value MC≦the use count value CNT≦the life duration time count value LC is displayed in the display section 22 (step S18).

In FIG. 7, an example of the notification screen 221 to be displayed in the display section 22 in step S18 of FIG. 6 is shown. As shown in FIG. 7, name of the part to be replaced and a message for urging replacement of a unit in which the part P to be replaced is installed are displayed in the notification screen 221. Further, a message for asking whether to transfer to the maintenance mode or not is displayed. When the YES key 213 of the key input section 21 is pushed, the process is transferred to the maintenance mode. When the NO key 214 of the key input section 21 is pushed, the image forming apparatus is switched to a standby state.

When the YES key 213 of the key input section 21 is pressed to instruct the process to transfer to the maintenance mode in a condition where the notification screen 221 is displayed in the display section 22 (step S19; YES), the maintenance mode process is executed (step S20) and the process is finished. When the NO key 214 of the key input section 21 is pushed to instruct the process not to transfer to the maintenance mode in a condition where the notification screen 221 is displayed in the display section 22 (step S19; NO), the image forming apparatus is switched to a standby state (step S21) and the process is finished.

In the above described print process, when the use count value CNT of one part P reached the life duration time count value LC, a notification screen 221 which urges to replace the one part P and the other parts P in which the use count value CNT is within the range between the replacement time count value MC and the life duration time count value LC (called, period Z) is displayed in the display section 22. The notification screen 221 is also displayed in a case where breakdown occurs in any of the parts P and the units. Then, when the YES key 213 of the key input section 21 is pushed in a condition where the notification screen 221 is displayed in the display section 22 to transfer to the maintenance mode, the maintenance mode process is executed.

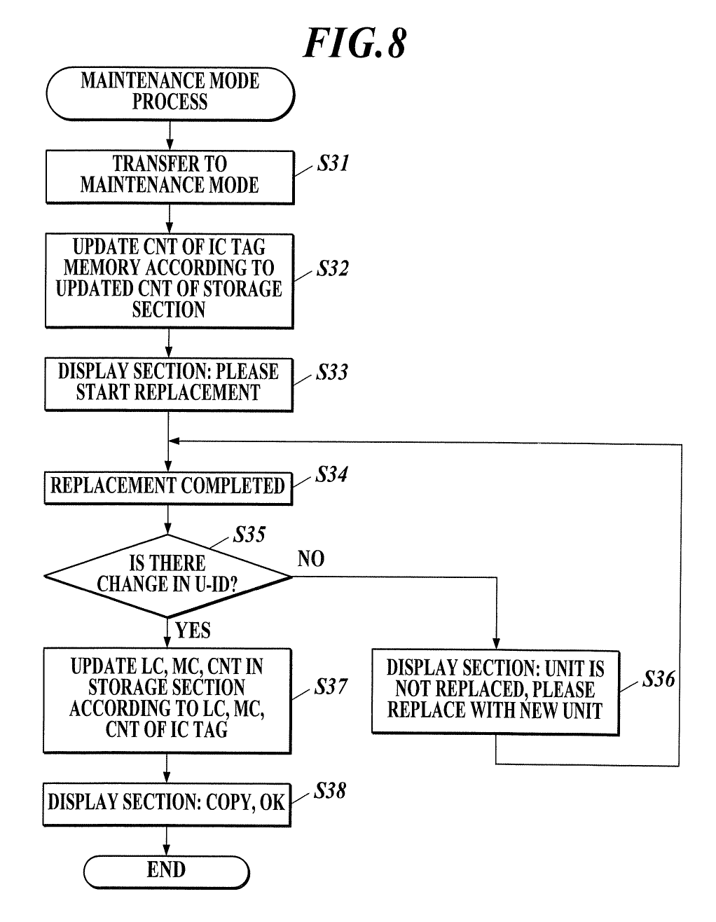

In FIG. 8, a flow of the maintenance mode process to be executed in the control section 10 is shown.

First, the image forming apparatus is switched to the maintenance mode and power supply to the scanner section 30, the printer section 50 and the like is stopped (step S31). Next, the use count value CNT of each part P in each of the IC tags 70 is updated according to the updated use count value CNT in the storage section 11 via the reader/writer section 60 (step S32). Thereafter, a message such as “Please start replacement” or the like is displayed in the display section 22 (step S33). Here, a message such as “Please push YES key when replacement is completed” or the like is also displayed in the display section 22 and an input of replacement completion is awaited.

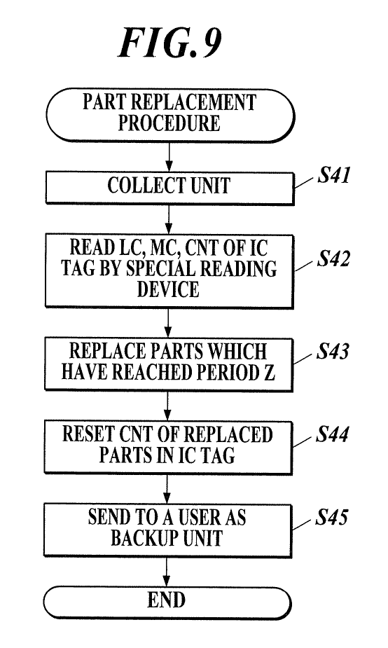

Here, a user pulls out a unit in which the part P which is urged to be replaced in the display section 22 is installed from the printer section 50 to carry out a unit replacement. The unit to be newly installed is a backup unit which followed the after-mentioned part replacement procedure by a service man (see FIG. 9) or a unit which is constituted with brand new parts P.

When the YES key 213 of the key input section 21 is pushed and when an input indicating replacement completion is carried out (step S34), the U-ID is read from the IC tag 70 of the unit which is the replacement target and whether the U-ID of the unit which is the replacement target is changed or not is determined by comparing to the U-ID of the unit which is stored in the storage section 11 (step S35). When it is determined that the U-ID of the unit which is the replacement target is not changed (step S35; NO), a message urging replacement such as “Unit is not replaced. Please replace with new unit.” or the like is displayed in the display section 22 (step S36) and the process returns to waiting for the input of replacement completion of step S34.

When it is determined that the U-ID of the unit which is the replacement target is changed (step S35; YES), the U-ID in the storage section 11 is updated to the U-ID of the unit which is replaced, and also, the life duration time count value LC, the replacement time count value MC, the use count value CNT of each part P stored in the IC tag 70 of the pertinent unit are read to update the life duration time count value LC, the replacement time count value MC and the use count value CNT in the storage section 11 according to the read values (step S37). Then, power supply to the scanner section 30, the printer section 50 and the like is resumed, and also, a message such as “copy, OK” or the like is displayed in the display section 22 (step S38) and the process is finished.

The unit which is pulled out from the case of the printer section 50 by a user in the above maintenance mode process is to be replaced by a service man in the procedure shown in FIG. 9. Hereinafter, the part replacement procedure carried out by a service man will be described.

First, a unit is collected (step S41). Next, the life duration time count value LC, the replacement time count value MC and the use count value CNT of the IC tag 70 which is attached to the unit is read by a special IC tag reader/writer (step S42).

Subsequently, the read life duration count value IC, replacement time count value MC, use count value CNT are referred to replace the part P which has reached the period Z with a new part P (step S43). Next, the use count value CNT of the replaced part P in the IC tag 70 is reset (step S44). Then, the unit in which the part P is replaces is sent to a user as a backup unit (step S45).

As described above, in the part replacement carried out by a service man, only the use count value CNT of the part P which is replaced with a new part P is reset and the use count value CNT remains as it is for the parts P which are not replaced. Then, when the unit is sent to a user as a backup unit and when a unit replacement is carried out during the maintenance mode process shown in FIG. 8, the use count value CNT is started from 0 for the new part P. However, counting of number of sheets printed is carried out from the use count value CNT which shows the number of times the part is used until now for the parts P other than the new part P which have been used. In such way, each of the parts P can be continuously used until reaching the period Z.

Here, other than the above described maintenance mode process, it can be assumed that a user carries out the unit replacement when the power source is OFF. Thus, when turning OFF of the power source is instructed by the key input section 21, the control section 10 updates the use count value CNT of the IC tag 70 of each of the units U1 to Un according to the updated use count value CNT in the storage section 11. When the power supply is turned ON, the unit replacement check process shown in FIG. 5 is executed. Therefore, variance does not occur in the use count value CNT of each of the parts P even when the unit replacement is carried out when the power supply is OFF.

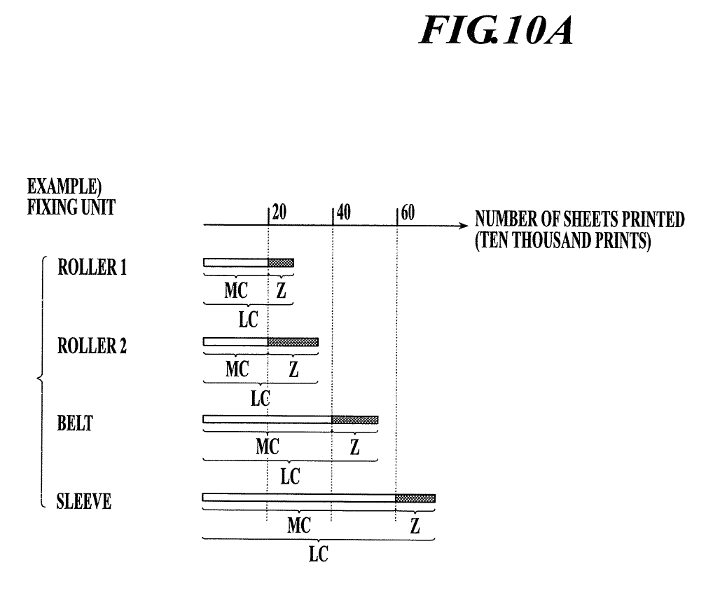

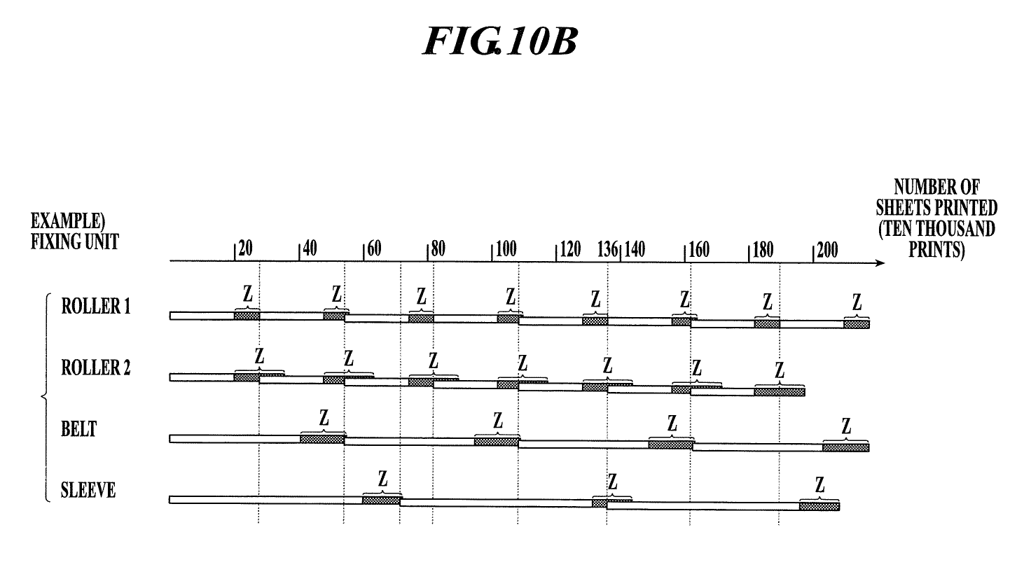

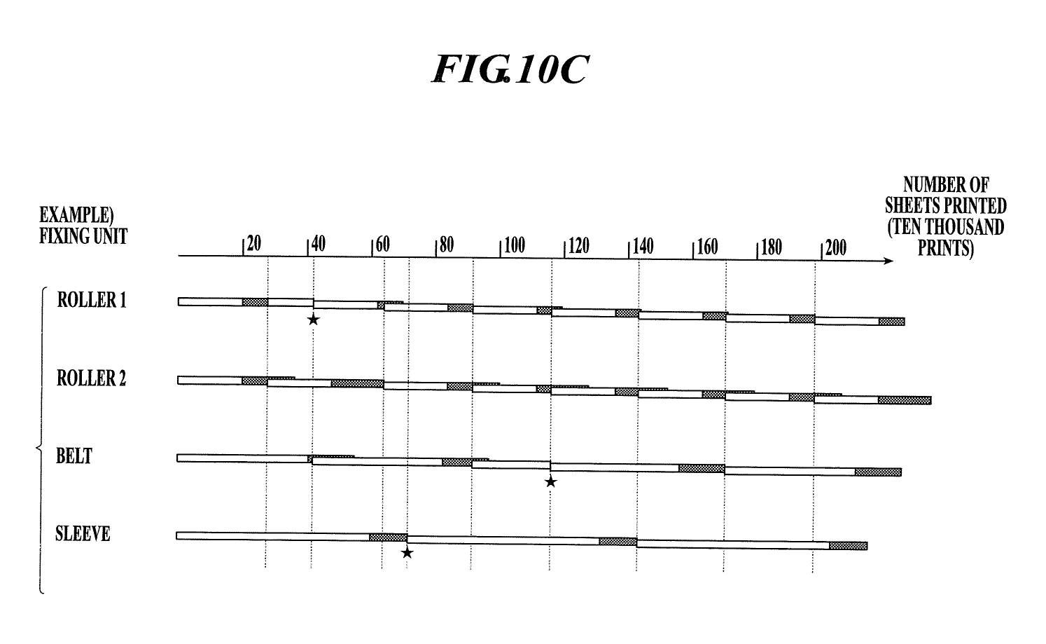

FIGS. 10A to 10C are diagrams for explaining part replacement time in the image forming apparatus 100. The FIG. 10A shows the replacement time count value MC, the life duration time count value LC and the period Z which is between the replacement time count value MC and the life duration time count value LC of a roller 1, a roller 2, a belt and a sleeve installed in the fixing unit 63. FIG. 10B shows a unit replacement which takes place when 2 million prints are carried out without each part P breaking down in one fixing unit 63 in which each of the parts P having the replacement time count value MC, the life duration time count value LC and the period Z shown in FIG. 10A (shown in dashed line in FIG. 10B). FIG. 10C shows a unit replacement which takes place when the roller 1 breaks down just when the number of sheets printed exceeded 400,000, when the sleeve breaks down just when the number of sheets printed exceeded 700,000 and when the belt breaks down just when the number of sheets printed exceeded 1,100,000 for one fixing unit 63 in which each part P having the replacement time count value MC, the life duration time count value LC and the period Z shown in FIG. 10A (shown in dashed line in FIG. 10C).

Here, when unit replacement is carried out before the number of sheets printed of the one fixing unit 63 reaches 2 million, the one fixing unit 63 will be temporarily removed from the image forming apparatus 100. However, when the unit is reinstalled, as shown in the part replacement procedure of a service man in FIG. 9, the use count value CNT of the replaced part P will be reset to 0 and the use count value CNT of the part P which is not replaced will be carried over. Therefore, the relation between the use count value CNT of each part P in the same fixing unit 63 and the unit replacement can be shown as in FIGS. 10B and 10C.

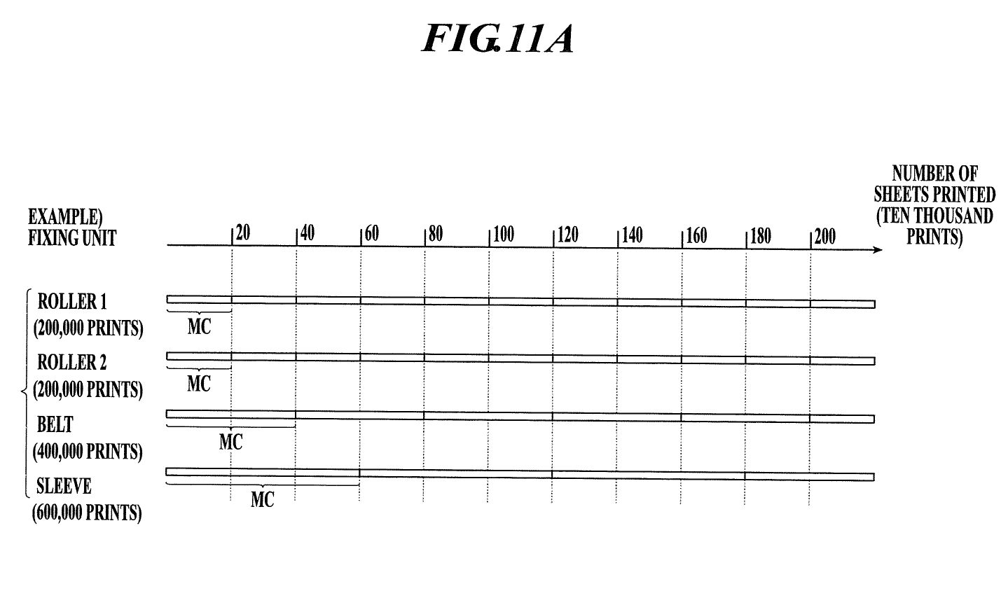

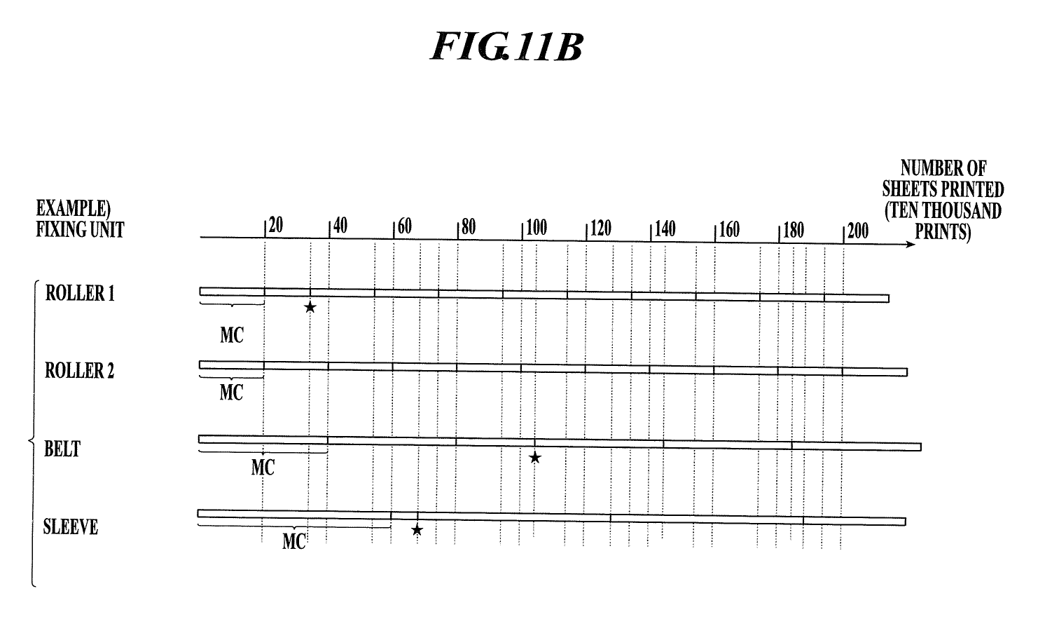

According to the image forming apparatus 100 of the embodiment, when a part P in the units U1 to Un reached the life duration time count value LC, it is determined whether any other parts P which have reached the period Z exist among other parts P or not by the print process shown in FIG. 6. When it is determined that other part P which have reached the period Z exists, a notification screen 221 indicating to replace the part P which has reached the period Z at the same time along with the part P which have reached the life duration time count value LC is displayed. A user replaces the unit in which the part P which is notified by the notification screen 221 is installed and a service man carried out the part replacement for the parts which are in the period Z in the replaced unit. In particular, as shown in FIG. 10B, when the roller 1 reached the life duration time count value LC at about 1,360,000 prints, the fixing unit 63 is replaced and the roller 2 and the sleeve which are in the period Z will also be replaced. In such case, the number of times the unit replacement carried out by a user is 8 times up to 2 million prints. This shows that the frequency of unit replacement can be reduced comparing to the conventional replacement at the time of routine maintenance (10 times per 2 million prints) shown in FIG. 11A, and thus the down time can be attempted to be reduced. Further, as shown in FIG. 10C, when break down of the part P occurred three times before reaching the replacement time, the number of times of unit replacement carried out by a user up to 2 million print is 9 times. This shows that the frequency of unit replacement can be greatly reduced comparing to the conventional replacement at the time of routine maintenance (25 times per 2 million prints), and thus the down time can be attempted to be reduced greatly.

As in the above description, according to the image forming apparatus 100, when printing of the number of sheets to be printed which is instructed via the operation section 20 or the communication section 40 is executed, the control section 10 increments the use count value CNT for each part P in the storage section 11 by the number of prints. Subsequently, the control section 10 refers to the storage section 11 to determine whether a part P in which the life duration time count value LC=the use count value CNT exists or not. When a part P in which the life duration time count value LC=the use count value CNT exists, the control section 10 detects for part P in which the replacement time count value MC≦the use count value CNT≦the life duration time count value LC among other parts P and displays the notification screen to urge the replacement of all of the parts P in which the replacement time count value MC≦the use count value CNT≦the life duration time count value LC in the display section 22.

Therefore, when a part P in the printer section 50 reached the life duration time count value LC, the parts P (that is, the parts P which have reached the period Z) in which the replacement time count value MC≦the use count value CNT≦the life duration time count value LC are also replaced at the same time. As a result, as shown in FIGS. 10B and 10C, the frequency of a user carrying out the unit replacement can be reduced and the down time can be attempted to be reduced.

In each units U1 to Un, the IC tag 70 in which the replacement time count value MC, the life duration time count value LC and the use count value CNT of each part P installed in the unit is stored so as to correspond to the each part P is attached. When the units U1 to Un are installed, the control section 10 reads the replacement time count value MC, the life duration time count value LC and the use count value CNT of each part P installed in the unit which are storage in the IC tag 70 of the unit by the reader/writer section 60 and stores the read values in the storage section 11. Therefore, even when the part P having different replacement time count value MC and the life duration time count value LC is installed as the part P of same function by the part replacement, the replacement time can be managed according to the installed part P.

Here, the above description of the embodiment is a preferable example of the image forming apparatus 100 and the present invention is not limited to this.

For example, in the above embodiment, a description is given by taking a case where the units U1 to Un which constitute the printer section 50 as an example. However, the present invention can be applied to units constituting the scanner section 30 and the like.

Further, detail structure and detail operation of each device constituting the image forming apparatus 100 can be arbitrarily changed within the scope of the present invention.

The entire disclosure of Japanese Patent Application No. filed on Jun. 19, 2008 is incorporate herein by reference in its entirety.

What is claimed is:

1. An image forming apparatus, comprising:
a replaceable unit in which a plurality of replaceable parts are installed;
a storage section to store a replacement time count value showing a replacement time of each or the parts installed in the unit, a life duration time count value showing a life duration time of each of the parts and a use count value showing a number of times of use of each of the parts;
a display section; and
a control section to update the use count value in the storage section by counting the number of times of use of each of the parts installed in the unit, to determine whether a part which reached the life duration time exists or not based on the use count value of each of the parts which are update and the life duration time count value, and to display information for urging a replacement of the part which reached the life duration time and a part in which the use count value reached between the replacement time count value and the life duration time count value in the display section when the control section determines that the part which reached the life duration time exists.

2. The image forming apparatus or claim 1, wherein
a recording medium in which the replacement time count value of each of the parts installed in the unit, the life duration time count value showing the life duration time of each of the parts and the use count value showing the number of times of use of each of the parts are stored so as to correspond to each of the parts is attached to the unit,
the image forming apparatus comprises a reader/writer section to carryout a reading of a data from the recording medium and a writing of a data to the recording medium in a condition where the unit is installed in the image forming apparatus, and
when a new unit is installed, the control section reads the replacement time count value, the life duration time count value and the use count value of each of parts installed in the new unit which are recorded in the recording medium of the new unit and stores in the storage section.

3. The image forming apparatus of claim 2, wherein
identification information of the unit to which the recording medium is attached is recorded in the recording medium, and
the control section reads the identification information recorded in the recording medium by the reader/writer section and stores the identification information in the storage section, and the control section determines whether the unit is replaced or not based on whether the identification information newly read from the recording medium by the reader/writer section is changed from the identification information stored in the storage section.

4. The image forming apparatus of claim 3, wherein
the control section displays the information for urging the replacement of the part which reached the life duration time and the part in which the use count value reached between the replacement time count value and the life duration time count value in the display section, thereafter, the control section compares the identification information stored in the storage section to the identification information newly read by the reader/writer section and displays information urging to replace with a new unit when the identification information is not changed.
